(19) United States
(12) Patent Application Publication
(10) Pub. No.: US 2025/0216152 A1
(43) Pub. Date: Jul. 3, 2025

(54) DRYING APPARATUS

(71) Applicant: SZ ZUVI TECHNOLOGY CO., LTD., Shenzhen (CN)

(72) Inventors: Jianping HUANG, Shenzhen (CN); Mingyu WANG, Shenzhen (CN); Xingwang XU, Shenzhen (CN); Yin TANG, Shenzhen (CN); Tongyao HUANG, Shenzhen (CN)

(73) Assignee: SZ ZUVI TECHNOLOGY CO., LTD., Shenzhen (CN)

(21) Appl. No.: 19/087,631

(22) Filed: Mar. 24, 2025

Related U.S. Application Data
(63) Continuation of application No. PCT/CN2023/137943, filed on Dec. 11, 2023.

(51) Int. Cl. F26B 21/00; A45D 20/12

(52) U.S. Cl. CPC F26B 21/004; A45D 20/12; F26B 21/003

(57) ABSTRACT

The present disclosure discloses a drying apparatus (10), comprising a housing (11) with an air inlet (111), the drying apparatus (10) further comprises: an airflow generating element (14) configured to effect an airflow within the housing (11), wherein an airflow direction downstream of the airflow generating element (14) is a first direction; an air guide (12) coupled to the housing (11) and located upstream of the airflow generating element (14); wherein the air guide (12) comprises a plurality of sub-portions (121), and each sub-portion (121) comprises a ventilation part (1212) through which the airflow passes and an air guiding part (1211) configured to guide the airflow to the ventilation part (1212); wherein the air inlet (111) is configured to guide the airflow entering the housing (11) from the air inlet (111) to each of the air guiding parts (1211).

### CROSS-REFERENCE TO RELATED APPLICATIONS

This application is a Continuation of International Application No. PCT/CN2023/137943, filed on Dec. 11, 2023, the contents of each of which are hereby incorporated by reference.

### TECHNICAL FIELD

The present disclosure relates to the technical field of drying equipment, and more particularly relates to drying apparatus.

### BACKGROUND OF THE INVENTION

A hair dryer is a device capable of outputting hot air. When a user uses a hair dryer, the airflow generating element inside the hair dryer operates and draws in external air from an air inlet to form an airflow. In the prior art, some hair dryers have been developed that are provided with auxiliary airflow channels in addition to a main air duct for outputting airflow outwards, and after introducing airflow into the auxiliary airflow channels, it is expected that the auxiliary airflow channels can dissipate heat from related internal structures.

However, due to the main air duct generating a large negative pressure, most of the airflow near the air inlet is drawn into its interior, resulting in the auxiliary airflow channels having difficulty drawing in air to form sufficient airflow, and failing to achieve their design purpose.

### SUMMARY

The present disclosure provides a drying apparatus, comprising a housing with an air inlet, and further comprises an airflow generating element configured to effect an airflow within the housing, wherein an airflow direction downstream of the airflow generating element is a first direction; an air guide coupled to the housing and located upstream of the airflow generating element; wherein the air guide comprises a plurality of sub-portions, and each sub-portion comprises a ventilation part through which the airflow passes and an air guiding part configured to guide the airflow to the ventilation part; wherein the air inlet is configured to guide the airflow entering the housing from the air inlet to each of the air guiding parts.

In the drying apparatus of embodiments of the present disclosure, the air guide cooperates with the air inlet, and may distribute the inhaled airflow into a primary airflow channel and an auxiliary airflow channel according to a preset ratio, so that both the primary airflow channel and the auxiliary airflow channel have sufficient airflow to achieve their respective design purposes.

Additional aspects and advantages of embodiments of the present disclosure will be partially given in the description below, and partially become apparent from the description below, or be understood through practice of the present disclosure.

### BRIEF DESCRIPTION OF THE DRAWINGS

The foregoing and/or additional aspects and advantages of the present disclosure will become apparent and readily understood from the detailed description of the embodiments in conjunction with the following accompanying drawings, wherein:

FIG. 1 is a schematic diagram of partial structures of a drying apparatus in some embodiments of the present disclosure;

FIG. 2 is a schematic diagram of a housing and an air guide in some embodiments of the present disclosure;

FIG. 3 is a schematic diagram of an air guide in some embodiments of the present disclosure;

FIG. 4 is a schematic diagram of an air guide according to other embodiments of the present disclosure;

FIG. 5 and FIG. 6 are schematic diagrams of a filter assembly of a drying apparatus in some embodiments of the present disclosure;

FIG. 7 is a schematic diagram of a drying apparatus with a detached filter assembly in some embodiments of the present disclosure;

FIG. 8 is a schematic diagram of a filter assembly in some embodiments of the present disclosure;

FIG. 9 is a schematic diagram of a filter assembly with a detached dust cover in some embodiments of the present disclosure;

FIG. 10 is a schematic diagram of a dust cover in some embodiments of the present disclosure;

FIG. 11 is a schematic diagram of the overall structure of a drying apparatus in some embodiments of the present disclosure.

### DETAILED DESCRIPTION OF THE INVENTION

The embodiments of the present disclosure are described in detail below, and examples of said embodiments are shown in the drawings wherein the same or similar designations denote the same or similar elements or elements having the same or similar functions throughout. The embodiments described below by reference to the drawings are illustrative and are intended to explain the embodiment of the present disclosure only and should not be construed as a limitation on the embodiment of the present disclosure.

In the description of this disclosure, it is necessary to understand that the terms “center”, “longitudinal”, “horizontal”, “length”, “width”, “thickness”, “up”, “down”, “front”, “back”, “left”, “right”, “vertical”, “horizontal”, “top”, “bottom”, “inner”, “outside”, “clockwise”, “counterclockwise”, such orientation or positional relationship indicated is based on the orientation or positional relationship shown in the drawings, only for the convenience of describing the present disclosure and simplifying the description, and does not indicate or imply that the apparatus or element referred to must have such specific orientation, be constructed and operated in such particular orientation, and therefore cannot be construed as a limitation on the present disclosure. In the description of this disclosure, “plurality” means two or more than two, unless otherwise expressly and specifically qualified.

In the description of the present disclosure, it is noted that, unless otherwise expressly specified or qualified, the terms “attached”, “connected”, “connected” are to be understood broadly, for example, they may be fixed, detachable, or integrally connected. It may be mechanically or electrically connected. It may be directly connected or indirectly connected through an intermediate medium, it may be the internal connection of two elements or the interaction relationship between two elements. For those of ordinary skill in the art, the specific meaning of the above terms in the present disclosure may be understood on a case-by-case basis.

In the present disclosure, unless otherwise expressly specified and qualified, the first feature “above” or “below” the second feature may include direct contact between the first and second features, or the first and second features are not in direct contact but through additional feature contact between them. Moreover, the first feature is “above”, “above”, and “above” the second feature comprises the first feature directly above and obliquely above the second feature, or simply indicates that the first feature is horizontally higher than the second feature. The first feature is “below”, “below”, and “below” the second feature, comprising the first feature directly below and diagonally below the second feature, or simply indicating that the horizontal height of the first feature is less than that of the second feature.

The publication of this disclosure provides a number of different embodiments or examples to implement the different structures of the present disclosure. In order to simplify the disclosure of the present disclosure, the parts and settings for specific examples are described in this disclosure. They are only examples and are not intended to limit the present disclosure. In addition, the present disclosure may repeat the reference numbers and/or reference letters in different examples, and this repetition is for the purpose of simplification and clarity and does not in itself indicate the relationship between the various embodiments and/or settings in question. In addition, the present disclosure provides examples of various specific processes and materials, but those of ordinary skill in the art may be aware of The present disclosure of other processes and/or the use of other materials.

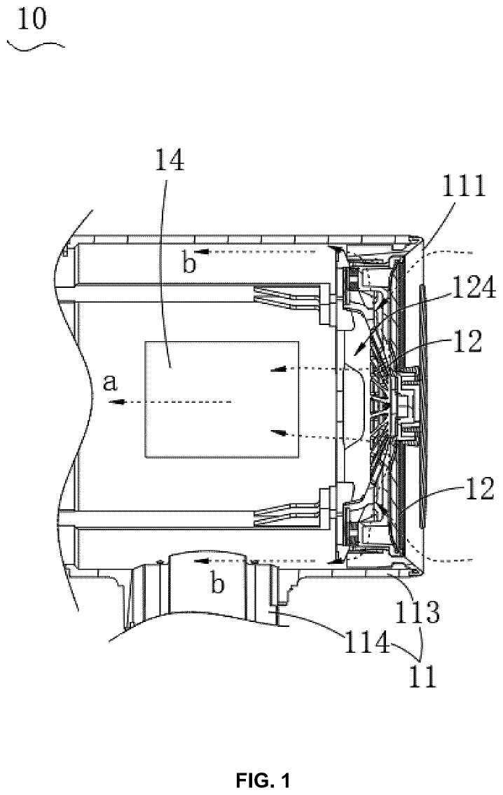

As shown in FIG. 1, a drying apparatus 10 according to an embodiment of the present disclosure is provided, comprising a housing 11, an airflow generating element 14, and an air guide 12. The drying apparatus 10 outputs airflow outwards during operation to dry a target object. The drying apparatus 10 may be a hair dryer, and the corresponding target object is hair; the drying apparatus 10 may also be a hand dryer, a clothes dryer, etc.

A plurality of airflow channels is formed inside the housing 11. The airflow channel where the airflow generating element 14 is located is referred to as a primary airflow channel a, and the other airflow channels are referred to as auxiliary airflow channel B. In the figure, dashed arrows indicate the approximate airflow direction of airflow in each part, wherein the airflow direction downstream of the airflow generating element 14 in the primary airflow channel A is the first direction. When the airflow generating element 14 is operating, negative pressure is generated in the primary airflow channel a, and air is drawn in from the outside to form a high-speed airflow. After being output from the housing 11, the high-speed airflow is used to dry the target object. Affected by the primary airflow channel a, an airflow is also formed in the auxiliary airflow channel B. The airflow may dissipate heat from related structures in the auxiliary airflow channel B (such as circuit boards, motor control boards, radiation elements, power supply elements and other heat-generating structures). This may dissipate heat and at the same time avoid these structures affecting the smoothness of the airflow in the primary airflow channel A.

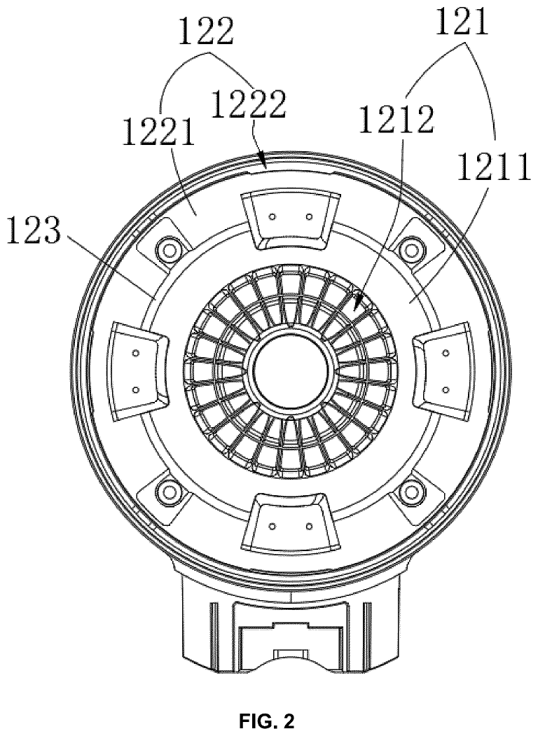

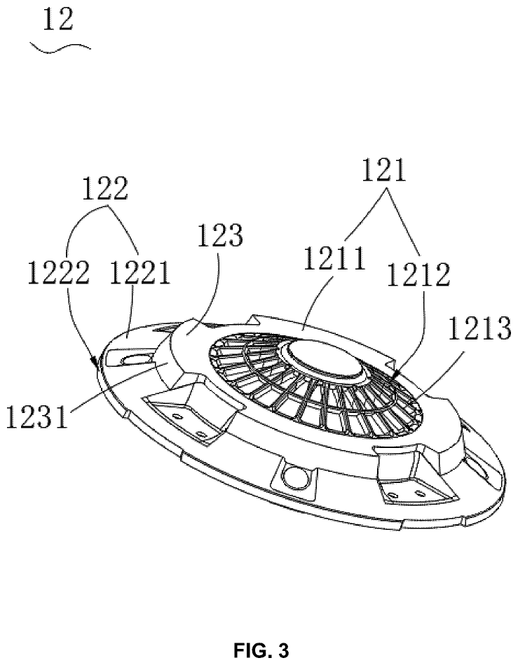

Referring to FIG. 1, FIG. 2, and FIG. 3, the air guide 12 is coupled in the housing 11 and located upstream of the airflow generating element 14. The air guide 12 comprises a plurality of sub-portions, with each sub-portion corresponding to each airflow channel. For ease of description, the sub-portion corresponding to the primary airflow channel A is referred to as a first sub-portion 121, and the sub-portion corresponding to the auxiliary airflow channel B is referred to as a second sub-portion 122. It is easy to understand that the drying apparatus 10 comprises at least one primary airflow channel A and one auxiliary airflow channel b. Therefore, the air guide 12 at least comprises a first sub-portion 121 and a second sub-portion 122. In other embodiments, the drying apparatus 10 comprises a greater number of auxiliary airflow channel B, and the number of sub-portions on the air guide 12 may be plural, such as three, five, six, etc., wherein at least one sub-portion corresponds to the primary airflow channel a, and a plurality of sub-portions respectively correspond to the auxiliary airflow channel B.

The following description takes an example where the drying apparatus 10 comprises one primary airflow channel A and one auxiliary airflow channel B to illustrate various embodiments of the present disclosure. Correspondingly, the air guide 12 comprises a first sub-portion 121 and a second sub-portion 122, and the two are adjacent. The following related descriptions involving the coupling between the first sub-portion 121 and the second sub-portion 122. In other embodiments, the air guide 12 comprises more sub-portions, and the related descriptions of the connection correspond to the coupling relationship between any two adjacent sub-portions, and should not be understood as specifically referring to the coupling relationship between the first sub-portion 121 corresponding to the primary airflow channel A and the second sub-portion 122 corresponding to the auxiliary airflow channel B.

In the first sub-portion 121, at least a partial region defines a first ventilation part 1212, and at least a partial region defines a first air guiding part 1211. Wherein the first ventilation part 1212 is configured for airflow to pass through, that is, airflow located outside the air guide 12 (facing the outside of the drying apparatus 10) may enter the inside of the air guide 12 (facing the inside of the drying apparatus 10) from the first ventilation part 1212, and enter the primary airflow channel A. The first air guiding part 1211 is configured to guide airflow to the first ventilation part 1212. In other words, a part of the airflow flowing to the first sub-portion 121 directly enters the primary airflow channel A from the first ventilation part 1212, and another part is guided and then enters the primary airflow channel A from the first ventilation part 1212.

Similarly, for the airflow flowing to the second sub-portion 122, a part directly enters the auxiliary airflow channel B from the second ventilation part 1222, and another part is guided by the second air guiding part 1221 to the second ventilation part 1222, and then passes through the second ventilation part 1222 to enter the auxiliary airflow channel B.

The housing 11 is configured with an air inlet 111. The air inlet 111 is located upstream of the air guide 12 and in communication with the air of the external environment. The air inlet 111 is configured to guide the airflow passing through it, and guide the airflow entering the housing 11 from the air inlet 111 to each air guiding part.

When the drying apparatus 10 is operating, because the airflow generating element 14 is located in the primary airflow channel a, the length of the airflow channel from the first ventilation part 1212 to the airflow generating element 14 is less than the length of the airflow channel from the second ventilation part 1222 to the airflow generating element 14; and/or, the overall airflow resistance from the first ventilation part 1212 to the airflow generating element 14 is less than the overall airflow resistance from the second ventilation part 1222 to the airflow generating element 14. Correspondingly, a larger negative pressure is formed at the first ventilation part 1212, and a smaller negative pressure is formed at the second ventilation part 1222.

Under the premise that the total airflow amount entering the drying apparatus 10 from the air inlet 111 remains unchanged, the more airflow enters the primary airflow channel a, the less airflow enters the auxiliary airflow channel B, and vice versa. The more airflow enters the auxiliary airflow channel B, the less airflow enters the primary airflow channel A. For simplicity of expression below, the ratio of the airflow amount of the primary airflow channel A to the airflow amount of the auxiliary airflow channel B is simply referred to as the primary-auxiliary airflow ratio.

The larger the primary-auxiliary airflow ratio, the less airflow in the auxiliary airflow channel B. Too little airflow in the auxiliary airflow channel B will make it difficult to achieve effective heat dissipation for related structures. The smaller the primary-auxiliary airflow ratio, the less airflow in the primary airflow channel A. Too little airflow in the primary airflow channel A will lead to insufficient drying efficiency. Moreover, since the negative pressure of the primary airflow channel A is greater than the negative pressure of the auxiliary airflow channel B, it is easy to cause the primary-auxiliary airflow ratio to be too large. To this end, the air guide 12 in embodiments of the present disclosure cooperates with related structures to ensure that the primary-auxiliary airflow ratio is in a suitable range, so that both the primary airflow channel A and the auxiliary airflow channel B have sufficient airflow to achieve their respective design purposes.

Specifically, the air in the external environment is guided twice before entering the primary airflow channel A and the auxiliary airflow channels b:

The first guiding: the air inlet 111 guides the airflow to each of the first air guiding parts 1211 and the second air guiding parts 1221. It may also be understood that the purpose of the first guiding is to prevent a straight airflow channel from being formed between the first ventilation part 1212, the second ventilation part 1222 and the external environment.

The second guiding: the first air guiding part 1211 guides the airflow to the first ventilation part 1212 and enters the primary airflow channel a, and the second air guiding part 1221 guides the airflow to the second ventilation part 1222 and enters the auxiliary airflow channel B.

By adjusting the area and location of the first air guiding part 1211, the second air guiding part 1221, and the actual guiding direction of the air inlet 111, etc., the proportion of airflow affected by the first air guiding part 1211 and the second air guiding part 1221 from the air inlet 111 may be changed, thereby changing the primary-auxiliary airflow ratio. More specifically, the larger the area of the first air guiding part 1211 or second air guiding part 1221 and the closer the position is to the downstream of the airflow direction of the air inlet 111, the greater the proportion of airflow obtained, and vice versa, the smaller the proportion of airflow obtained.

With regard to the two guidings above, if the first guiding is missing, for example, the air guide 12 is directly exposed to the external environment, a straight airflow channel may be formed between the first ventilation part 1212, the second ventilation part 1222 and the external environment. According to aerodynamics, airflow will pass along the shortest path to the area with the greatest negative pressure. Therefore, almost all airflow will pass along a straight path to the first ventilation part 1212, and only weak airflow will flow to the second ventilation part 1222.

If the second guiding is missing, for example, the air inlet 111 directly guides airflow to the first ventilation part 1212 and the second ventilation part 1222, the first ventilation part 1212 still forms a straight airflow channel with the external environment, resulting in almost all airflow entering the primary airflow channel a, and only weak airflow entering the auxiliary airflow channel B. In the above two situations, the first air guiding part 1211 and the second air guiding part 1221 may not perform guiding and distributing airflow, eventually leading to an excessively large primary-auxiliary airflow ratio.

It may be seen from the above content that the drying apparatus 10 in embodiments of the present disclosure guides airflow to pass through the air inlet 111 and the air guide 12, which may control the primary-auxiliary airflow ratio, so that both the primary airflow channel A and the auxiliary airflow channel B have sufficient airflow.

In some embodiments as shown in FIG. 3, the first air guiding part 1211 and the second air guiding part 1221 on the air guide 12 are configured adjacently. It may also be understood that on the air guide 12, the first ventilation part 1212 and the second ventilation part 1222 are separated by the first air guiding part 1211 and the second air guiding part 1221. The air inlet 111 only needs to guide the airflow to the area where the first air guiding part 1211 and the second air guiding part 1221 are located, and the first air guiding part 1211 and the second air guiding part 1221 respectively guide the airflow on their surfaces to the first ventilation part 1212 and the second ventilation part 1222. In this way, the guiding precision requirement at the air inlet 111 may be lower, and it is sufficient to roughly determine that the overall direction of the airflow points to the area where the two air guiding parts are located. Moreover, by adjusting the proportion of the area occupied by the first air guiding part 1211 and the second air guiding part 1221 in the area where they are located, the primary-auxiliary airflow ratio may be adjusted. In other embodiments not shown, the first air guiding part 1211 and the second air guiding part 1221 are not configured adjacently, and the air inlet 111 correspondingly guides airflow to the first air guiding part 1211 and the second air guiding part 1221 respectively.

In some embodiments as shown in FIG. 3, a step structure 123 is defined between the first air guiding part 1211 and the second air guiding part 1221. Wherein the first air guiding part 1211 defines the top of the step structure 123, and the second air guiding part 1221 defines the bottom of the step structure 123. The step structure 123 comprises a step sidewall 1231 connecting the first air guiding part 1211 and the second air guiding part 1221.

The step sidewall 1231 forms a large airflow resistance to the airflow passing towards it. The airflow flowing from the bottom of the step to the top of the step will be affected by the airflow resistance of the step sidewall 1231; conversely, the airflow flowing from the top of the step to the bottom of the step may directly cross the step sidewall 1231, and is hardly affected by the airflow resistance of the step sidewall 1231. Therefore, the step structure 123 may function as a one-way air guide.

Specifically, the airflow of the first air guiding part 1211 located at the top of the step may pass along the first air guiding part 1211 to the first ventilation part 1212, and may also cross the step structure 123 to flow to the second air guiding part 1221. However, when the airflow of the second air guiding part 1221 located at the bottom of the step flows towards the first air guiding part 1211, it will be hindered by the airflow resistance of the step sidewall 1231, making it difficult to cross over to the top of the step, and may only flow to the second ventilation part 1222.

According to the foregoing embodiments, the first ventilation part 1212 corresponding to the primary airflow channel A forms a larger negative pressure, and the second ventilation part 1222 corresponding to the auxiliary airflow channel B forms a smaller negative pressure. When the negative pressure difference between the two is large, the airflow located at the second air guiding part 1221 will be affected by the negative pressure of the first ventilation part 1212 and flow to the first ventilation part 1212, eventually leading to an excessively small intake air volume of the auxiliary airflow channel B. After setting up the step structure 123 described above, a one-way airflow resistance may be formed to block the airflow of the second air guiding part 1221 from flowing to the first ventilation part 1212, thereby ensuring that there is sufficient airflow in the auxiliary airflow channel B.

In addition, adjusting the angle of the step sidewall 1231, the closer the angle between it and the plane at the bottom of the step structure 123 (that is, the second air guiding part 1221) is to a right angle, the greater the airflow resistance formed by the step sidewall 123 becomes. Adjusting the size of the step sidewall 1231 (that is, the distance between the top and bottom of the step structure 123 in the axial direction of the air guide 12), the larger the area of the step sidewall 1231, the more airflow it may affect. Both of the above situations will increase the airflow entering the second ventilation part 1222, that is, reduce the primary-auxiliary airflow ratio. Therefore, without changing other structures and parameters in the drying apparatus 10, the primary-auxiliary airflow ratio may be adjusted by adjusting the angle and size of the step sidewall 1231. It should be noted that a plurality of ways of adjusting the primary-auxiliary airflow ratio mentioned above and below should be understood as that these ways may not only adjust the primary-auxiliary airflow ratio alone, but also jointly achieve the adjustment of the primary-auxiliary airflow ratio, and the following will not repeat the description.

In other embodiments not shown, a two-way airflow resistance structure may be designed at the coupling location of the first air guiding part 1211 and the second air guiding part 1221, for example, a convex ring structure. Its outer wall faces the second air guiding part 1221 and forms a large airflow resistance, and its inner wall faces the first air guiding part 1211 and forms a large airflow resistance. With the convex ring structure as the boundary, airflow may not flow between the first air guiding part 1211 and the second air guiding part 1221.

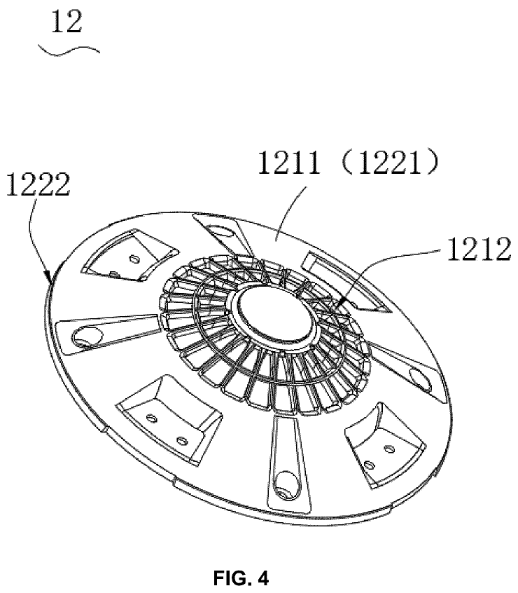

In some embodiments shown in FIG. 4, the first air guiding part 1211 and the second air guiding part 1221 on the air guide 12 are defined on the same plane. It may also be understood that there is no obvious boundary between the first air guiding part 1211 and the second air guiding part 1221. The airflow may flow freely along this plane, which comprises lower airflow resistance and airflow noise. Such is suitable for the drying apparatus 10 with a small negative pressure difference between the first ventilation part 1212 and the second ventilation part 1222.

The above-mentioned “same plane” is not limited to a plane, for example, as shown in FIG. 4, the air guide 12 comprises a curved surface, and both the first air guiding part 1211 and the second air guiding part 1221 are formed on the curved surface. In other embodiments not shown, the air guide 12 comprises a plane, and the first air guiding part 1211 and the second air guiding part 1221 are formed on the plane. In other embodiments not shown, the first air guiding part 1211 and the second air guiding part 1221 are not on the same plane, but the connecting part between the two is a smooth curved surface, and there is no obvious change in airflow resistance when airflow flows between the first air guiding part 1211 and the second air guiding part 1221.

In some embodiments as shown in FIG. 2 and FIG. 3, in any plane perpendicular to the first direction, the first sub-portion 121 is circular or annular, and the second sub-portion 122 is annular and surrounds the outer side of the first sub-portion 121. The step structure 123 is defined at the boundary therebetween. The central area of the air guide 12 defines the first sub-portion 121, corresponding to the primary airflow channel A. In some more specific embodiments, the axis of the airflow generating element 14 coincides with the axis of the air guide 12, and the first sub-portion 121 is annularly arranged around the axis of the air guide 12 near the central area to ensure uniform air intake in the radial direction of the primary airflow channel A.

The outer edge area of the air guide 12 defines the second sub-portion 122, corresponding to the auxiliary airflow channel B surrounding the outer edge of the primary airflow channel A. Other related structures are configured between the primary airflow channel A and the auxiliary airflow channel B to isolate the two to avoid airflow mixing affecting the airflow smoothness in the primary airflow channel A.

In some more specific embodiments, the inner wall of the housing 11 defines one sidewall of the auxiliary airflow channel B. When the airflow in the auxiliary airflow channel B flows along the inner wall of the housing 11, it may dissipate heat from the housing 11, so that the user will not feel overheated when touching the housing 11 of the drying apparatus 10.

As shown in FIG. 2 and FIG. 3, in some more specific embodiments, in any plane perpendicular to the first direction, the projections of the first ventilation part 1212, the first air guiding part 1211, the second air guiding part 1221, and the second ventilation part 1222 form nested circular or annular shapes sequentially from large to small. In conjunction with FIG. 1, the projection of the air inlet 111 forms an annular or circular shape, and at least partially overlaps with the shapes formed by the projections of the first air guiding part 1211 and the second air guiding part 1221.

When the airflow generating element 14 is operating, negative pressure is formed inside the housing 11. After airflow enters from the annular or circular air inlet 111, it will be guided to flow to the first air guiding part 1211 and the second air guiding part 1221, and is uniformly distributed in the radial direction along the annular or circular shape, and flows to the first ventilation part 1212 and the second ventilation part 1222, so that the primary airflow channel A and the auxiliary airflow channel B uniformly intake air in the radial direction, and each defines relatively smooth airflow.

In some embodiments as shown in FIG. 3, a shape of a partial region of the first sub-portion 121 is of the shape of any one of a truncated pyramid, a truncated cone, a pyramid, and a cone, which comprises an inclined sidewall 1213 inclined relative to the first direction. One or more first through holes through which airflow may pass are configured on the inclined sidewall 1213, and define the first ventilation part 1212. The inclined first ventilation part 1212 not only helps to reduce airflow noise when guiding the airflow, but also guide the passing through airflow to a certain extent.

In addition, the larger the inclination angle of the inclined sidewall 1213, the larger its surface area, and the larger the area of the first ventilation part 1212 that may be accommodated, which is equivalent to increasing the air intake volume of the primary airflow channel A. Therefore, adjusting the inclination angle of the inclined sidewall 1213 may also adjust the primary-auxiliary airflow ratio.

In some embodiments as shown in FIG. 3, along the first direction, the second air guiding part 1221 expands outwards and defines an inclined air guiding surface. The inner edge of the air guiding surface defines the bottom of the step structure 123, and the outer edge is coupled to the second ventilation part 1222. The airflow flowing to the second air guiding part 1221 may be guided to the second ventilation part 1222 along the inclined air guiding surface. The purpose of inclining the air guiding surface is still to reduce airflow noise during air guiding.

In some embodiments as shown in FIG. 3, the air guiding surface defined by the second air guiding part 1221 and the air inlet surface of the second ventilation part 1222 are located on the same plane. In this way, the airflow may pass along the air guiding surface and smoothly enter the second ventilation part 1222, and no airflow noise will be generated between the two. It should be noted that the above-mentioned “same plane” is not limited to a “plane” in the mathematical sense, but may also be a curved surface or an arc surface with curvature in space, as long as there is no obvious curvature mutation and/or smooth transition at the joint. In the figure, the air guiding surface defined by the second air guiding part 1221 is roughly a part of a side surface of a cone, and correspondingly, the air inlet surface of the second ventilation part 1222 is also a part of the side surface of a cone.

In some embodiments as shown in FIG. 2, the outer edge of the air guide 12 and the housing 11 are not sealed, and a gap through which airflow may pass is defined between the two. The gap also defines the second ventilation part 1222. In some specific embodiments, a complete gap defined along the circumferential direction of the air guide 12 and surrounding the air guide 12 forms an annular second ventilation part 1222. In other specific embodiments, a plurality of notches is circumferentially and spaced apart on the air guide 12, and the gaps are defined at each notch respectively. A plurality of notches as a result defines a second ventilation part 1222 spaced apart along an annular shape. The parts without notches may be positioned by coupling with the housing 11 to ensure axial positioning between the air guide 12 and the housing 11. In each of the above embodiments. By adjusting the size of the gap, for example, increasing or decreasing its size, the actual air intake area of the second ventilation part 1222 may be changed in order to adjust the primary-auxiliary airflow ratio.

In the above embodiments, the second air guiding part 1221 is actually jointly defined by the air guide 12 and the housing 11. That is, the air guide 12 defines a part of the second air guiding part 1221. In other embodiments not shown, one or more second through holes through which airflow may pass are defined in the second sub-portion 122 of the air guide 12, and a plurality of second through holes defines the second ventilation part 1222. In this way, the airflow passing through the second ventilation part 1222 does not pass through the housing 11. It may also be understood that the entire second air guiding part 1221 is defined by the air guide 12. By adjusting the size of the second through holes, for example, increasing or decreasing the inner diameter of the second through holes, the actual air intake area of the second ventilation part 1222 may be changed in order to adjust the primary-auxiliary airflow ratio.

In some embodiments as shown in FIG. 1 and FIG. 3, the middle portion of the air guide 12 protrudes away from the airflow generating element 14, and defines a concave cavity 124 on the side facing the airflow generating element 14. The upstream of the airflow generating element 14 communicates with the concave cavity 124. At least a part of the first ventilation part 1212 is configured on the sidewall of the concave cavity 124, and the second ventilation part 1222 is not in direct communication with the concave cavity 124.

The airflow of the first sub-portion 121 may enter the concave cavity 124 from the first ventilation part 1212, and the airflow generating element 14 directly draws air from the concave cavity 124 and forms a high-speed airflow in the primary airflow channel A. Without changing the outer diameter of the air guide 12 (this dimension will affect the assembly relationship with the housing 11), the greater the protrusion of the middle portion of the air guide 12, the larger the surface area of the sidewall of the concave cavity 124, and the larger the size of the first ventilation part 1212. Thereby, increasing the air intake volume of the primary airflow channel A in order to adjust the primary-auxiliary airflow ratio.

The airflow of the second sub-portion 122 does not enter the concave cavity 124, but enters the auxiliary airflow channel B from the second ventilation part 1222, thereby separating the airflow of the primary airflow channel A and the auxiliary airflow channel B on the air guide 12.

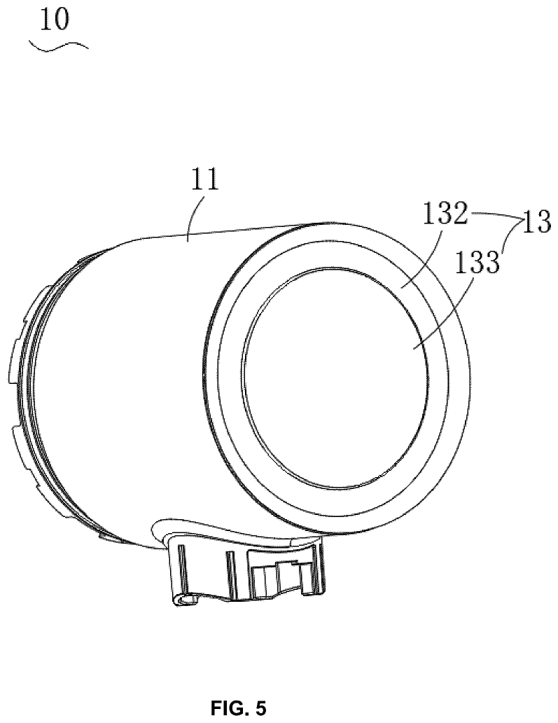

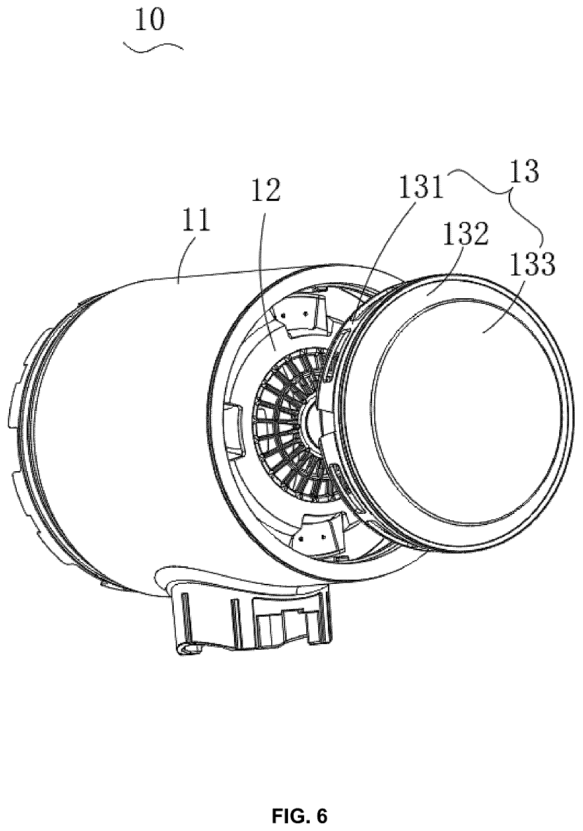

In some embodiments as shown in FIG. 5 to FIG. 8, the drying apparatus 10 further comprises a filter assembly 13 configured to filter the airflow entering the drying apparatus 10 to prevent foreign objects from entering the housing 11 with the airflow.

The filter assembly 13 comprises a base 131, a filter 132, and a dust cover 133. Wherein, the base 131 is detachably coupled to the air guide 12 and/or the housing 11 to position the filter assembly 13 with the housing 11 through coupling.

The filter 132 is coupled to the base 131, covering the downstream of the air inlet 111 and located on the necessary path of airflow. All airflow entering from the air inlet 111 passes through the filter 132 and is filtered. In some specific embodiments, the filter 132 comprises a plurality of layers of filter mesh with different pore sizes, with each layer of filter mesh filtering foreign objects of different sizes. In other specific embodiments, the filter 132 also comprises a filter element with a three-dimensional structure. In other specific embodiments, the filter 132 comprises an inlet grille to block large-sized foreign objects, such as paper, cloth, etc.

The dust cover 133 is detachably coupled to the air guide 12 and/or the base 131, and the dust cover 133 defines at least a part of the air inlet 111. The air inlet 111 may be understood as a part of the drying apparatus 10 that may directly exchange airflow with the external environment, or it may also be understood as the most upstream part of all structures of the entire drying apparatus 10. In some specific embodiments, the dust cover 133 itself defines a complete air inlet 111, that is, airflow only passes through the dust cover 133 when entering the drying apparatus 10. In other embodiments, the dust cover 133 and other structures, such as the housing 11, the base 131, etc., jointly define the air inlet 111. That is, airflow passes through the dust cover 133 and other structures when entering the drying apparatus 10.

The “detachably coupled” of the above-mentioned base 131 and dust cover 133 means that the user may install or detach them in a preset manner as needed. When both the base 131 and the dust cover 133 are coupled, the drying apparatus 10 may be used normally. Unless otherwise specified below, both the base 131 and the dust cover 133 are in the coupled state.

When one or both of the base 131 and the dust cover 133 are detached, the filter assembly 13 may be cleaned to different degrees, specifically including the following states:
(a) The base 131 is in the coupled state, and the dust cover 133 is detached. At this time, the user may clean the outer surface of the filter 132 (the surface facing the outside of the drying apparatus 10) to remove foreign objects accumulated on the outer surface of the filter 132 and keep its outer surface clean.
(b) The dust cover 133 is in the coupled state, and the base 131 is detached. At this time, the user may clean the inner surface of the filter 132 (the surface facing the inside of the drying apparatus 10). Moreover, since the entire filter assembly 13 is detached from the housing 11, it may be directly deep-cleaned as a whole by water washing, vacuum cleaner, etc.
(c) Both the dust cover 133 and the base 131 are detached. At this time, the user may thoroughly clean each part of the filter assembly 13.

In some specific embodiments, the user applies force to the dust cover 133 to drive the entire filter assembly 13 to be detached from the housing 11, and directly enters the above state (b) for cleaning. If the cleaning needs are not met, the dust cover 133 is further detached from the base 131 to enter the above state (c) for cleaning.

In other specific embodiments, the user applies force to the dust cover 133, and the dust cover 133 itself is detached from the base 131 to enter the above state (a) for cleaning. If the cleaning needs are not met, the base 131 is further detached from the housing 11 to enter the above state (c) for cleaning.

In some specific embodiments, the base 131 and the air guide 12 are mutually coupled by magnetic connection. When the user detaches the filter assembly 13, the user applies a force opposite to the magnetic force to the filter assembly 13, and pulls the filter assembly 13 away from the housing 11. In other embodiments, the detachable coupling between the filter assembly 13 and the air guide 12 or the housing 11 may be realized by using snap-fitting, bolts, or other means. In other embodiments, structures such as rubber rings and spring plungers may be arranged between the filter assembly 13 and the housing 11 to make the two have greater friction force when moving relative to each other, and the detachable coupling of the filter assembly 13 may also be realized.

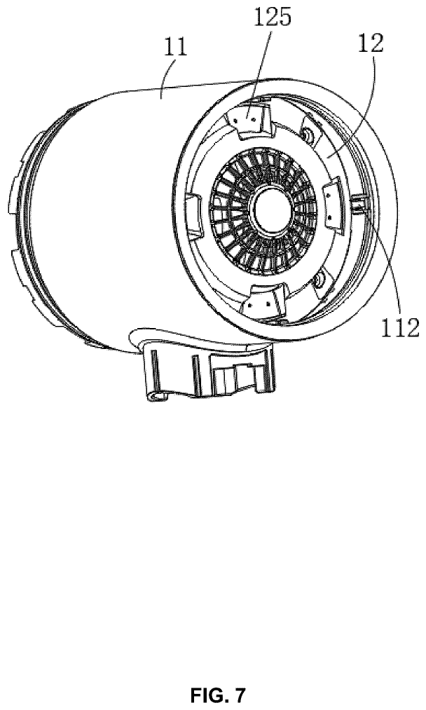

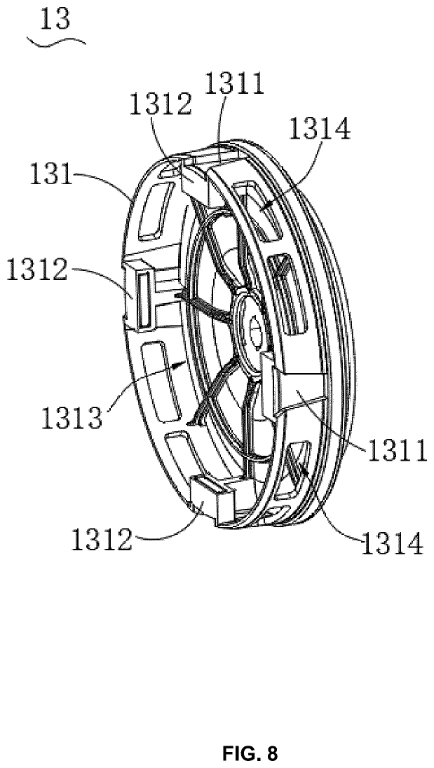

In some more specific embodiments as shown in FIG. 7 and FIG. 8, the air guide 12 is configured with at least one coupled portion 125 formed of iron, and the base 131 is correspondingly configured with at least one magnetic part 1312 with magnetic force. Moreover, at least one coupled portion 125 is configured with a Hall sensor (not shown) for detecting whether the magnetic part 1312 is in place. The Hall sensor is an electrical component that may detect magnetic force. When the filter assembly 13 is in the coupled state, the magnetic part 1312 and the coupled portion 125 are mutually attracted, and the coupled portion 125 may guide magnetism so that the Hall sensor detects the magnetic force and outputs an in-place signal. In other embodiments, photoelectric sensors, distance sensors, cameras combined with image recognition, Bluetooth or RFID wireless communication, and other methods may also be used to recognize whether the filter assembly 13 is in place.

If the user forgets to re-couple the filter assembly 13 to its original position after detaching it for cleaning, the Hall sensor may not detect the magnetic force and does not send an in-place signal. In some specific embodiments, the drying apparatus 10 is also provided with structures such as indicator lights, buzzers, and displays, which may send prompt information in combination with the in-place signal to prompt the user whether the drying apparatus 10 is currently equipped with the filter assembly 13. In some specific embodiments, the control strategy of the drying apparatus 10 is configured to: not be able to start operation when no in-place signal is received, so as to prevent the user from using the drying apparatus 10 without the filter assembly 13.

In some specific embodiments, the quantity of the coupled portions 125 is a plurality, and the coupled portions 125 are uniformly distributed along the circumferential direction of the air guide 12; the quantity of the magnetic parts 1312 is correspondingly a plurality, and the magnetic parts 1312 are uniformly distributed along the circumferential direction of the base 131. This may provide multi-position magnetic connection and increase the coupling firmness of the filter 13.

In some embodiments as shown in FIG. 7 and FIG. 8, a plurality of sets of guiding components are configured for guiding between the base 131 and the housing 11 and/or the air guide 12. The guiding component comprises a guiding groove 1311 and a guiding block 112 configured to slide in the guiding groove 1311.

When the user couples the filter assembly 13 into the housing 11, the guiding block 112 and the guiding groove 1311 cooperate with each other to realize guiding and positioning of the filter assembly 13, so that the magnetic part 1312 and the coupled portion 125 are kept in an aligned state with each other during the coupling process of the filter assembly 13. In this way, after the filter assembly 13 is coupled in place, the corresponding magnetic part 1312 and the coupled portion 125 may accurately contact each other and keep the filter assembly 13 in the coupled state through magnetic force.

The positioning of the guiding block 112 and the guiding groove 1311 are not limited. In some embodiments shown in FIG. 7 and FIG. 8, the guiding groove 1311 is configured on the base 131, and the guiding block 112 is configured on the air guide 12. In other embodiments not shown, the guiding block 112 is configured on the base 131, and the guiding groove 1311 is configured on the housing 11 and/or the air guide 12.

In some specific embodiments, the guiding block 112 and the guiding groove 1311 extend along the first direction. In the process of coupling the filter assembly 13 into the housing 11, the cooperation of the guiding block 112 and the guiding groove 1311 may restrict the sliding of the filter assembly 13 along the first direction to ensure that the filter assembly 13 may be coupled into the housing 11 in the correct direction without skewing.

In some specific embodiments, as shown in FIG. 7 and FIG. 8, one end of the guiding groove 1311 comprises an outwardly expanding inclined sidewall, so as to facilitate positioning when the guiding block 112 enters the guiding groove 1311. The outwardly expanding inclined sidewall makes the guiding groove 1311 have a larger insertion opening, reduces the positioning precision requirement for the guiding block 112 to be inserted into the guiding groove 1311, and makes the user's operation easier when coupling the filter assembly 13.

In some more specific embodiments, one end of the guiding block 112 comprises an inwardly contracting inclined end portion (not shown), so as to facilitate positioning when the guiding block 112 enters the guiding groove 1311. The inwardly contracting inclined end portion makes the guiding block 112 have a smaller insertion end, reduces the positioning precision requirement for the guiding block 112 to be inserted into the guiding groove 1311, and makes the user's operation easier when coupling the filter assembly 13.

In some more specific embodiments, one end of the guiding groove 1311 comprises an outwardly expanding inclined sidewall, and one end of the guiding block 112 comprises an inwardly contracting inclined end portion, which may further reduce the positioning precision requirement for the guiding block 112 to be inserted into the guiding groove 1311.

In some embodiments as shown in FIG. 8, the base 131 comprises a plurality of magnetic parts 1312, and a part of the magnetic parts 1312 defines the guiding groove 1311. The magnetic part 1312 of the base 131 is larger in size and correspondingly stronger than other parts in order to install a magnet. Setting the guiding groove 1311 here may compensate for the influence of grooving on the strength of the base 131, so that the overall strength of the base 131 meets the design requirements.

In some embodiments as shown in FIG. 8, the base 131 comprises an inner cavity 1313. The filter 132 is coupled to one end of the inner cavity 1313, and the other end of the inner cavity 1313 defines an opening. In combination with FIG. 1 to FIG. 3 and some of the foregoing embodiments, the first sub-portion 121 of the air guide 12 passes through the opening and is located in the inner cavity 1313. The airflow passing through the filter 132 and entering the inner cavity 1313 may flow to the first sub-portion 121 and enter the primary airflow channel A.

In combination with some of the foregoing embodiments, the middle portion of the air guide 12 protrudes away from the airflow generating element 14, and defines a concave cavity 124 on the side facing the airflow generating element 14. At least a part of the first ventilation part 1212 is defined on the sidewall of the concave cavity 124. And the greater the protrusion, the greater the air intake volume of the primary airflow channel A. Therefore, adjusting the shape and size of the protrusion of the air guide 12 may adjust the primary-auxiliary airflow ratio. The inner cavity 1313 of the base 131 may accommodate the protruding part of the air guide 12 so that the size and shape of the two are matched to avoid structural interference.

In some more specific embodiments as shown in FIG. 8, the sidewall of the inner cavity 1313 is configured with a plurality of lateral through holes 1314 through which airflow may pass. In combination with FIG. 1 to FIG. 3 and some of the foregoing embodiments, the second sub-portion 122 of the air guide 12 is located outside the inner cavity 1313, and the airflow flowing out from the lateral through holes 1314 flows to the second sub-portion 122 and enters the auxiliary airflow channel B. In other embodiments not shown, the part of the sidewall of the inner cavity 1313 other than the magnetic part 1312 may also be completely removed to increase the airflow volume entering the auxiliary airflow channel B.

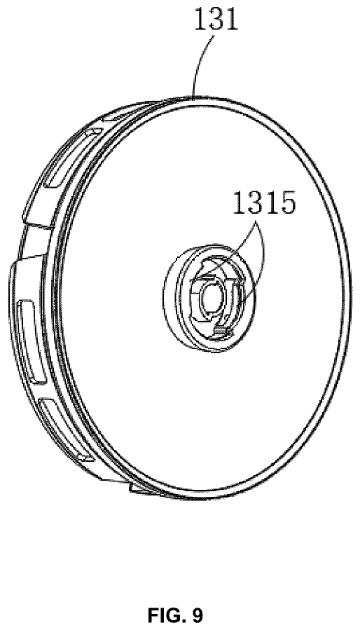

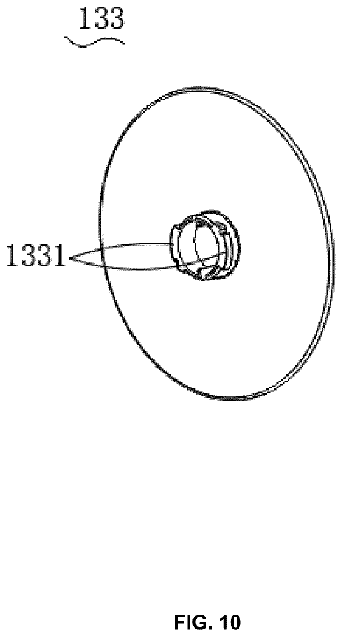

In some embodiments as shown in FIG. 9 and FIG. 10, a center of the dust cover 133 is configured with one or more first buckles 1331, and a center of the base 131 is configured with one or more second buckles 1315. The first buckles 1331 and the second buckles 1315 may be buckled to each other to realize the coupling between the dust cover 133 and the base 131.

Specifically, the first buckles 1331 and the second buckles 1315 are configured to:
at a preset position, when the dust cover 133 rotates along a first direction, the first buckles 1331 and the second buckles 1315 are buckled to each other, so that the dust cover 133 and the base 131 are mutually coupled;
at the preset position, when the dust cover 133 rotates along a second direction, the first buckles 1331 and the second buckles 1315 are separated from each other, so that the dust cover 133 and the base 131 are detached from coupling.

Since the action to couple and detach the dust cover 133 is rotation, and the force applied to couple and detach the base 131 is pulling, the coupling and detachment processes of the dust cover 133 and the base 131 will not interfere with each other. Specifically, when the user applies an outward pulling force to the dust cover 133, the pulling force will not drive the dust cover 133 to rotate. Therefore, the dust cover 133 may remain in the coupled state and serve as a bearing point for detaching the base 131, thereby detaching the base 131 from the housing 11 and pulling it out of the housing 11. Similarly, in the process of coupling the base 131 into the housing 11, when the user applies an inward pushing force to the dust cover 133, the dust cover 133 may also remain in the coupled state and serve as a bearing point.

In combination with FIG. 7, FIG. 8, and some of the foregoing embodiments, the guiding groove 1311 and the guiding block 112 are configured for guiding between the base 131 and the housing 11 and/or the air guide 12 so that the base 131 may not rotate relative to the housing 11. Therefore, when the user applies a second direction rotation force to the dust cover 133, the base 131 will not rotate therewith, and the dust cover 133 and the base 131 rotate relative to each other until the first buckles 1331 and the second buckles 1315 are separated from each other, and the dust cover 133 and the base 131 are detached from coupling. Similarly, when the user applies a first direction rotation force to the dust cover 133, the first buckles 1331 and the second buckles 1315 are buckled to each other, so that the dust cover 133 and the base 131 are mutually coupled.

In combination with some of the foregoing embodiments, the user may directly pull the dust cover 133 outward to detach the filter assembly 13 from the housing 11 as a whole; or the dust cover 133 may be rotated to detach the dust cover 133 separately. Or, after the user pulls the dust cover 133 outward to detach the filter assembly 13 from the housing 11, the user may then grip the base 131 and the dust cover 133 and apply a rotational force to further detach the dust cover 133 from the filter assembly 13.

In some embodiments as shown in FIG. 5, the dust cover 133 is circular or annular, and an annular air inlet 111 is defined between the edge of the dust cover 133 and the housing 11. The annular air inlet 111 may uniformly intake air in the radial direction.

In combination with the embodiments shown in FIG. 1 to FIG. 3, both the first air guiding part 1211 and the second air guiding part 1221 extend annularly. The annular air inlet 111 formed between the dust cover 133 and the housing 11 may make the airflow enter the housing 11 and pass along a roughly annular path to the first air guiding part 1211 and the second air guiding part 1221. In other embodiments, the dust cover 133 may also be of other shapes, and an annular air inlet 111 is provided on the dust cover 133. In other embodiments, the air inlet 111 may also include a plurality of ventilation holes or openwork areas that are defined on the housing 11 and distributed along an annular shape.

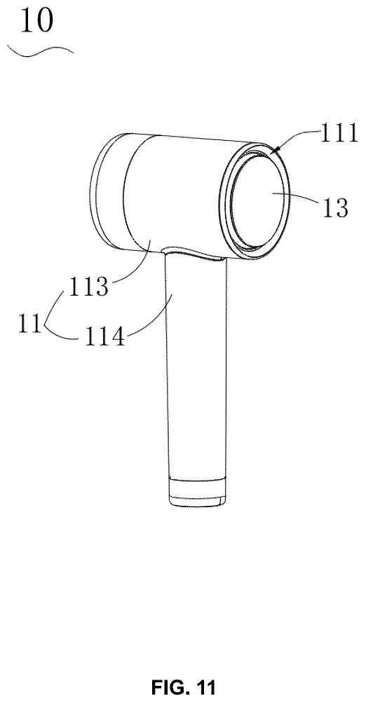

As shown in FIG. 11, in some embodiments, the housing 11 comprises a main body 113 and a handle 114, wherein the handle 114 is a part that may be held by the user, and the main body 113 is the part of the drying apparatus 10 that directly outputs airflow.

In some specific embodiments as shown in FIG. 11, the air inlet 111 of the drying apparatus 10 is defined on the main body 113. Therefore, the filter assembly 13 is also coupled to the main body 113, and airflow enters the main body 113 through the air inlet 111. Referring to FIG. 1 together, the aforementioned air guide 12 is coupled to the main body 113, and both the primary airflow channel A and the auxiliary airflow channel B are configured inside the main body 113.

In other embodiments not shown, the air inlet 111 of the drying apparatus 10 is defined on the handle 114, and the filter assembly 13 is correspondingly coupled to the handle 114. Airflow enters the handle 114 through the air inlet 111, and then flows into the main body 113 from the inside of the handle 114 along a preset path. The air guide 12 is coupled in the handle 114, and at least a part of the primary airflow channel A or the auxiliary airflow channel B is configured in the handle 114.

In other embodiments not shown, both the main body 113 and the handle 114 are configured with air inlets 111. Then filter assemblies 13 and air guides 12 are respectively coupled on the handle 114 and the main body 113, and airflow enters the main body 113 and the handle 114 respectively from the corresponding air inlets 111. In some more specific embodiments, the handle 114 and the main body 113 are coupled with completely identical air inlets 111, and correspondingly coupled with the same filter assemblies 13 and air guides 12. In other more specific embodiments, the air inlets 111 of the handle 114 and the main body 113 have different shapes and/or sizes, and correspondingly have different filter assemblies 13 and/or air guides 12, which may be a combination of any of the above embodiments.”

In the description of this specification, references to the terms “one embodiment”, “some embodiments”, “schematic embodiments”, “examples”, “specific examples” or “some examples”, etc., are intended to mean that the specific features, structures, materials or features described in conjunction with the embodiments or examples are contained in at least one embodiment or example of the present disclosure. In this specification, indicative representations of the above terms do not necessarily refer to the same embodiments or examples. Further, the specific features, structures, materials, or features described may be combined in an appropriate manner in any one or more embodiments or examples. In addition, without contradicting each other, those skilled in the art may combine and combine the different embodiments or examples described in this specification and the features of the different embodiments or examples.

Notwithstanding the above illustrations and descriptions of the embodiments of the present disclosure, it is understood that the said embodiments are illustrative and cannot be construed as limiting the present disclosure, and those skilled in the art may change, modify, replace and variate the said embodiments within the scope of the present disclosure.

What is claimed is:

1. A drying apparatus, comprising a housing with an air inlet, the drying apparatus further comprises:
an airflow generating element configured to effect an airflow within the housing, wherein an airflow direction downstream of the airflow generating element is a first direction;
an air guide coupled to the housing and located upstream of the airflow generating element'
wherein the air guide comprises a plurality of sub-portions, and each sub-portion comprises a ventilation part through which the airflow passes and an air guiding part configured to guide the airflow to the ventilation part;
wherein the air inlet is configured to guide the airflow entering the housing from the air inlet to each of the air guiding part.

2. The drying apparatus of claim 1, wherein two sub-portions are adjacent, and two air guiding parts are configured adjacently.

3. The drying apparatus of claim 2, wherein two adjacent air guiding parts form a step structure, one air guiding part defines a top of the step structure, and the other air guiding part defines a bottom of the step structure;
wherein the step structure comprises a step sidewall connecting the two air guiding parts, and the step sidewall is configured to block airflow from flowing from a bottom thereof to a top thereof.

4. The drying apparatus of claim 3, wherein the sub-portion comprises:
a first sub-portion, the first sub-portion comprises a first ventilation part and a first air guiding part,
wherein the first air guiding part is located at the top of the step structure;
a second sub-portion, the second sub-portion comprises a second ventilation part and a second air guiding part,
wherein the second air guiding part is located at the bottom of the step structure;
an airflow channel from the first ventilation part to the airflow generating element comprises a length less than an airflow channel from the second ventilation part to the airflow generating element; and/or, an overall airflow resistance from the first ventilation part to the airflow generating element is less than an overall airflow resistance from the second ventilation part to the airflow generating element.

5. The drying apparatus of claim 4, wherein in any plane perpendicular to the first direction, the first sub-portion is circular or annular, and the second sub-portion is annular and surrounds an outer side of the first sub-portion, and the step structure is formed at a boundary therebetween.

6. The drying apparatus of claim 4, wherein in any plane perpendicular to the first direction, projections of the first ventilation part, the first air guiding part, the second air guiding part, and the second ventilation part form nested circular or annular shapes sequentially from large to small;
a projection of the air inlet forms an annular or circular shape, and at least partially overlaps with shapes formed by projections of the first air guiding part and the second air guiding part.

7. The drying apparatus of claim 4, wherein a partial region of the first sub-portion is of the shape of any one of a truncated pyramid, a truncated cone, a pyramid, and a cone, which comprises an inclined sidewall inclined relative to the first direction;
a plurality of first through holes through which the airflow passes are defined on the inclined sidewall and are configured to form the first ventilation part.

8. The drying apparatus of claim 4, wherein along the first direction, the second air guiding part expands outward and defines an inclined air guiding surface;
an inner edge of the air guiding surface defines the bottom of the step structure, and an outer edge of the air guiding surface is coupled to the second ventilation part.

9. The drying apparatus of claim 8, wherein the air guiding surface and an air inlet surface of the second ventilation part are located on the same plane.

10. The drying apparatus of claim 4, wherein a plurality of second through holes through which airflow passes are defined in the second sub-portion and are configured to form the second ventilation part; or,
a gap between an outer edge of the air guide and the housing defines the second ventilation part.

11. The drying apparatus of claim 2, wherein the two adjacent air guiding parts are defined on the same plane, or
a smooth transition is defined between the two adjacent air guiding parts.

12. The drying apparatus of claim 11, wherein a shape of a partial region of the air guide is of the shape of any one of a truncated pyramid, a truncated cone, a pyramid, and a cone, which comprises an inclined sidewall inclined relative to the first direction, and two air guiding parts are defined on the inclined sidewall.

13. The drying apparatus of claim 4, wherein a middle portion of the air guide protrudes away from the airflow generating element, and defines a concave cavity on a side facing the airflow generating element, and
an upstream of the airflow generating element communicates with the concave cavity; at least a part of the first ventilation part is arranged on a sidewall of the concave cavity, and the second ventilation part is not in direct communication with the concave cavity.

14. The drying apparatus of claim 1, wherein the drying apparatus further comprises a filter assembly, the filter assembly including:
a base detachably coupled to the air guide and/or the housing;
a filter coupled to the base and covering the air inlet;
a dust cover detachably coupled to the air guide and/or the base, wherein the dust cover defines at least a part of the air inlet.

15. The drying apparatus of claim 14, wherein the air guide is configured with a plurality of first magnetic parts,
the base is configured with a plurality of second magnetic parts, and
the base and the air guide are mutually coupled by magnetic connection.

16. The drying apparatus of claim 15, wherein at least one first magnetic part is formed of iron, and
a Hall sensor for detecting whether the second magnetic part is in place is configured at a coupling portion.

17. The drying apparatus of claim 15, wherein a plurality set of guiding components are configured between the base and the housing and/or the air guide, and the guiding component comprises a guiding groove and a guiding block configured to slide in the guiding groove.

18. The drying apparatus of claim 14, wherein a center of the dust cover is configured with a plurality of first buckles, and a center of the base is configured with a plurality of second buckles, the first buckles and the second buckles are configured to:
at a preset position, when the dust cover rotates along a first direction, the first buckles and the second buckles are buckled to each other, so that the dust cover and the base are mutually coupled;
at the preset position, when the dust cover rotates along a second direction, the first buckles and the second buckles are separated from each other, so that the dust cover and the base are detached from each other.

19. The drying apparatus of claim 14, wherein the base comprises an inner cavity;
the filter is coupled to one end of the inner cavity, and the other end of the inner cavity defines an opening, and at least one sub-portion is located in the inner cavity and passes through the opening.

20. The drying apparatus of claim 14, wherein the housing comprises a main body and a handle;
the air guide and the filter assembly are coupled to the main body, and the airflow enters the main body through the air inlet; or,
the air guide and the filter assembly are coupled to the handle, and the airflow enters the handle through the air inlet; or,
the main body and the handle are respectively coupled with the air inlet structure and the filter assembly, and the airflow enters the main body and the handle respectively from corresponding air inlets.
